(19) United States
(12) Patent Application Publication
(10) Pub. No.: US 2021/0372646 A1
(43) Pub. Date: Dec. 2, 2021

(54) Hazardous Gas Evacuation System

(71) Applicants: Jon H. Brasher, Opelika, AL (US); Evelyn G. Boone, Opelika, AL (US)

(72) Inventors: Jon H. Brasher, Opelika, AL (US); Evelyn G. Boone, Opelika, AL (US)

(21) Appl. No.: 17/330,526

(22) Filed: May 26, 2021

Related U.S. Application Data
(60) Provisional application No. 63/029,746, filed on May 26, 2020.

(51) Int. Cl. F24F 11/32; F24F 7/007

(52) U.S. Cl. CPC F24F 11/32; F24F 2007/001; F24F 7/007

(57) ABSTRACT

A system and method for evacuating a harmful gas from an enclosed structure. The operation of the system is triggered by the detection of the harmful gas. Once triggered, normal air circulation through the HVAC duct is stopped. One or more separate evacuation blowers are activated and these pull the air withing the structure out. Some version are housed in a pass-through evacuation module within an existing HVAC duct. Other versions are housed within a combined register/evacuation module.

### CROSS-REFERENCES TO RELATED APPLICATIONS

This non-provisional patent application claims the benefit of U.S. Provisional Application Ser. No. 63/029,746. The provisional application was filed on May 26, 2020. It listed the same inventors.

### STATEMENT REGARDING FEDERALLY SPONSORED RESEARCH OR DEVELOPMENT

Not applicable

### MICROFICHE APPENDIX

Not applicable

### BACKGROUND OF THE INVENTION

### 1. Field of the Invention

The present invention pertains to the field of building design and maintenance. More specifically, the invention comprises a system and method for evacuating dangerous gases detected in an enclosed space.

### 2. Description of the Related Art

Harmful gases found in dwellings or other enclosed structures present a significant risk to the occupants. As an example, about 400 people are killed by carbon monoxide poisoning in the United States each year. In addition to the fatalities, carbon monoxide poisoning in the U.S. sends over 20,000 people per year to the emergency room. Most such victims survive. However, many survivors face long term residual effects—such as neurological damage.

Carbon monoxide detectors are now commonly installed in occupied structures—either as standalone units or as a component added to a smoke detector. These units are effective in detecting the presence of a harmful gas. Unfortunately, however, the occupants of a structure may be unable to respond to the warning provided by a detector. Poisoning events often occur while the victims are asleep. Carbon monoxide poisoning induces an even deeper sleep. Affected victims may not respond to any type of warning—including the very loud audible warnings provided by a detector.

Many home monitoring fire and security systems now include a remote notification feature that summons help. Thus, even if the occupants are incapacitated, emergency responders will travel to the scene. During the response period, however, the victims are still immersed in the environment containing the harmful gas.

The heating, ventilation, and air conditioning (“HVAC”) system in many structures exacerbate the problems posed by a dangerous gas. FIGS. 1 and 2 serve to illustrate this phenomenon. FIG. 1 shows a plan view of a typical residential structure. The living space in this structure is all contained on a single floor. An attic is provided above the living space. The attic is not heated or cooled, and must therefore be separated from the living space by a ceiling. The ceiling provides a barrier between the attic and the living space.

A single hallway 28 connects living room 12 to bedrooms 14,16,18,24,26. Bathrooms 20,22 are also provided. The living room includes a fireplace 52 with artificial “gas logs.” A kerosene-fueled space heater 54 is also located in the living room. Carbon monoxide (“CO”) detectors 48,50 are mounted on the ceiling. These detectors monitor for the presence of significant CO in the air within the building. If significant CO is detected they emit a loud alarm.

A central HVAC system supplies conditioned air to the living room, the bedrooms, and the bathrooms. Each of these rooms has a duct outlet mounted in its ceiling. Each such outlets is commonly referred to as an “air register.” A typical air register has an inlet for attachment to the duct, and an outlet that can be attached to an opening in the ceiling of a room. Steerable louvers are often provided in the air register's outlet. These can be used to direct the airflow from the particular register and to shut off the air flow if desired.

Living room 12 is fed by air registers 30,32. Air registers 34,36,38,44,46 feed the bedrooms. Air registers 40,42 feed the bathrooms. FIG. 2 depicts the HVAC system used to condition the air within the dwelling of FIG. 1. The HVAC system is located in the attic, directly above the living space. Air handler 56 draws in return air through air intake 58. The return air is forced over the heat exchanger within the air handler and expelled into two fixed ducts 60,62. The fixed ducts carry the conditioned air out to the various air registers. As an example, fixed duct 60 carries air to registers 34,36,38. In addition, flexible duct 64 carries air from the end of fixed duct 60 to register 30 in the living room. Likewise, flexible duct 66 carries air from the end of fixed duct 62 to register 32 in the living room.

The type of ducting used is not significant to the present invention. The term “fixed duct” generally applies to a rigid or semi-rigid structure made of sheet metal or—in more recent years—insulated foam board. The term “flexible duct” refers to a generally circular duct that can be easily bent as desired. The present invention can be used for both these types of ducts, and for other types as well.

The view of FIG. 2 serves to illustrate a common CO poisoning scenario. Carbon monoxide can be produced by a malfunction in either fireplace 52 or space heater 54. Such a problem often occurs when the devices are unattended—after the occupants have retired to the bedrooms and gone to sleep. The CO produced is pulled into the HVAC system's air intake 58. The HVAC system then distributes the CO throughout the structure—including into the bedrooms where the occupants are sleeping. A gradual increase in CO concentration can induce an even deeper sleep state.

At some point the CO detectors will be triggered and a loud tone will be emitted. In some instances of CO poisoning, the occupants are in such a deep sleep that the loud tone does not awaken them. The CO detection system does nothing to reduce the concentration of the CO. Its only function is to alert the occupants in the hope they will then act to escape the building. A system of automatically evacuating the gas upon its detection would provide significant advantages. The present invention provides such a system.

### BRIEF SUMMARY OF THE INVENTION

The present invention comprises a system and method for evacuating a harmful gas from an enclosed structure. The operation of the system is triggered by the detection of the harmful gas. Once triggered, normal air circulation through the HVAC duct is stopped. One or more separate evacuation blowers are activated and these pull the air within the structure out. Some version are housed in a pass-through evacuation module within an existing HVAC duct. Other versions are housed within a combined register/evacuation module.

### BRIEF DESCRIPTION OF THE SEVERAL VIEWS OF THE DRAWINGS

FIG. 1 is a plan view, showing an exemplary residential structure.

FIG. 2 is a plan view, showing an HVAC system used in the structure of FIG. 1.

FIG. 3 is a perspective view, showing an evacuation module configured for placement in an existing duct.

FIG. 4 is an elevation view, showing the operation of the evacuation module of FIG. 3.

FIG. 5 is an elevation view, showing the operation of the evacuation module of FIG. 3.

FIG. 6 is an elevation view, showing an alternate evacuation module that is incorporated in an air register.

FIG. 7 is an elevation view, showing the operation of the evacuation module of FIG. 6.

FIG. 8 is an elevation view, showing the operation of the evacuation module of FIG. 6.

FIG. 9 is a block diagram showing an exemplary control system for use in the present invention.

FIG. 10 is a block diagram, showing an exemplary control system used for an individual evacuation module.

FIG. 11 is a plan view, showing an exemplary installation of the inventive system.

### REFERENCE NUMERALS USED IN THE DRAWINGS

10 structure

12 living room

14 bedroom

16 bedroom

18 bedroom

20 bathroom

22 bathroom

24 bedroom

26 bedroom

28 hallway

30 air register

32 air register

34 air register

36 air register

38 air register

40 air register

42 air register

44 air register

46 air register

48 carbon monoxide detector

50 carbon monoxide detector

52 fireplace

54 space heater

56 air handler

58 air intake

60 fixed duct

62 fixed duct

64 flexible duct

66 flexible duct

68 evacuation module

70 duct coupler

72 intake

74 evacuation blower

76 motor

78 exhaust duct

80 evacuation valve

82 exit

84 exit valve

86 exit valve actuator

88 entrance

90 entrance valve

92 entrance valve actuator

94 ceiling

96 evacuation intake valve

98 evacuation blower input

100 register/evacuation module

102 coupler housing

104 blower valve

106 entrance valve

108 entrance

110 system controller

112 processor

114 memory

116 I/O port

118 I/O port

120 I/O port

122 tone detector

124 HVAC interface

126 I/O port

128 I/O port

130 I/O port

132 I/O port

134 I/O port

136 evacuation module

138 evacuation module

140 evacuation module

142 attic fan

144 transceiver

146 evacuation module controller

148 I/O port

150 processor

152 memory

156 I/O port

158 I/O port

160 I/O port

162 valve actuator

164 valve actuator

166 evacuation duct

168 evacuation duct

170 attic fan

### DETAILED DESCRIPTION OF THE INVENTION

The present invention is suitable for removing virtually any type of dangerous gas, as well as suspended particulates—such as smoke produced by a fire. The following examples pertain to the removal of carbon monoxide. However, the invention is not limited to the removal of this particular type of dangerous gas.

The invention incorporates one or more evacuation modules in the HVAC ducting of a building. A central function of each evacuation module is to pull the contaminated air out of an enclosed structure and exhaust it outside the living space of the structure. There are two main types of evacuation module. The first type is an “in-line” module—meaning that it is placed in an HVAC duct so that air traveling in the duct ordinarily goes completely through the evacuation module and continues onward in another segment of the duct. The second type is an “air register module” where the evacuation module is located at the end of the duct (and forms part of an air register feeding normal HVAC flow into the living space of a building).

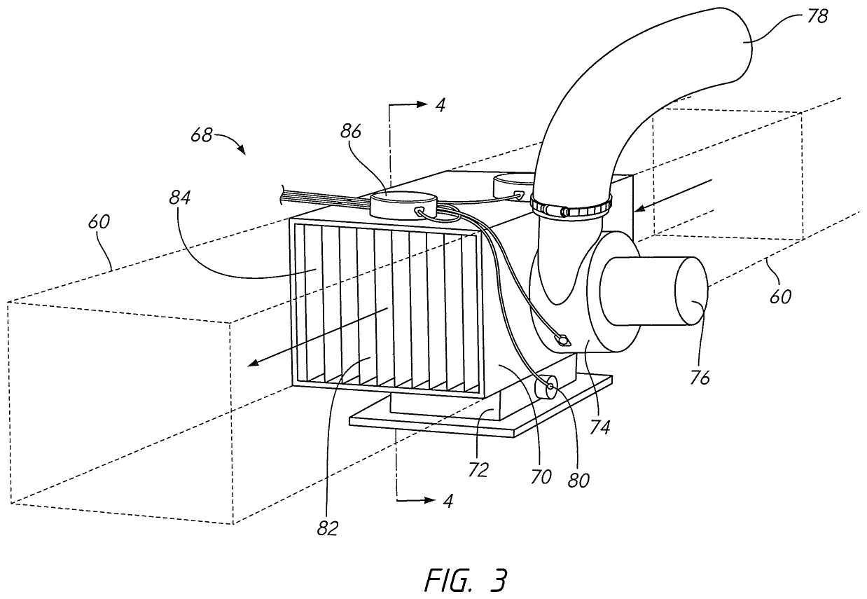

FIG. 3 show an in-line version. Evacuation module 68 is located in fixed duct 60. Duct coupler 70 is part of the evacuation module. It mates to the duct on each end. Air normally flowing through duct 60 flows into the far end of duct coupler 70 and out exit 82 in the near end of duct, coupler 70 (“near end” and “far end” referring to the orientation shown in the view).

Closure valves are placed on the entrance and the exit of duct coupler 70. In the example shown, each closure valve assumes the form of a movable set of louvers. Exit valve 84 is shown in the view. It is open—as is the entrance valve—so that air is allowed to pass normally through the duct.

Evacuation intake 72 also connects to duct coupler 70. The evacuation intake connects to the living space within the building. In the version shown, the evacuation intake assumes the form of an additional air register in the ceiling of the room serviced by this particular evacuation module 68. The evacuation intake is ordinarily closed. It is only opened when evacuation of the air within the living spaces becomes necessary. Evacuation valve actuator 80 is provided to selectively open the valve allowing air into evacuation intake 72.

Evacuation blower 74 is provided to positively extract air through evacuation intake 72 when evacuating the air within the living spaces. Electrical motor 76 powers evacuation blower 74. The evacuated air propelled out of blower 74 is carried out exhaust duct 78. In the example shown the exhaust duct is a flexible tube connected to a larger exhaust system. In other examples the exhaust duct may simply be a part of evacuation blower 74 itself.

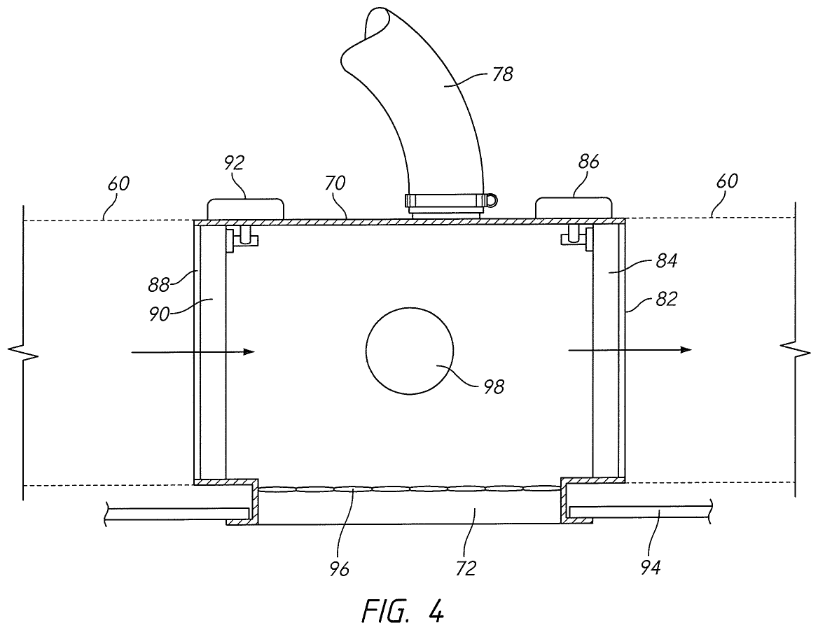

In FIG. 3 orientation “callouts” are provided for the view of FIG. 4. FIG. 4 is a sectional elevation view through the evacuation module 68 of FIG. 3. In FIG. 4, the view is taken from the side opposite the evacuation blower. FIG. 4 shows the state of the evacuation module when the HVAC is operating normally (and the inventive evacuation system is not operating).

Duct air passes into duct coupler 70 through entrance 88 and passes out through exit 82. A valve selectively closes the entrance and the exit. Entrance valve 90 selectively closes the entrance. It is actuated by entrance valve actuator 92. Exit valve 84 selectively closes the exit. It is actuated by exit valve actuator 86. Both valves in this example comprise a set of louvers. Both entrance valve 90 and exit valve 84 are shown in the open state in FIG. 4. HVAC air flows freely through duct coupler 70 as indicated by the arrows.

Evacuation intake 72 is closed off by evacuation intake valve 96—which in this example is another louver-type valve. The reader will note that the evacuation inlet 72 in this example assumes the form of an air register. It is mounted in an opening in ceiling 94. Evacuation blower inlet 98 feeds into the evacuation blower. It may optionally be closed by a valve as well. However, when the blower is off, an additional valve is not generally needed to stop unwanted flow through the blower.

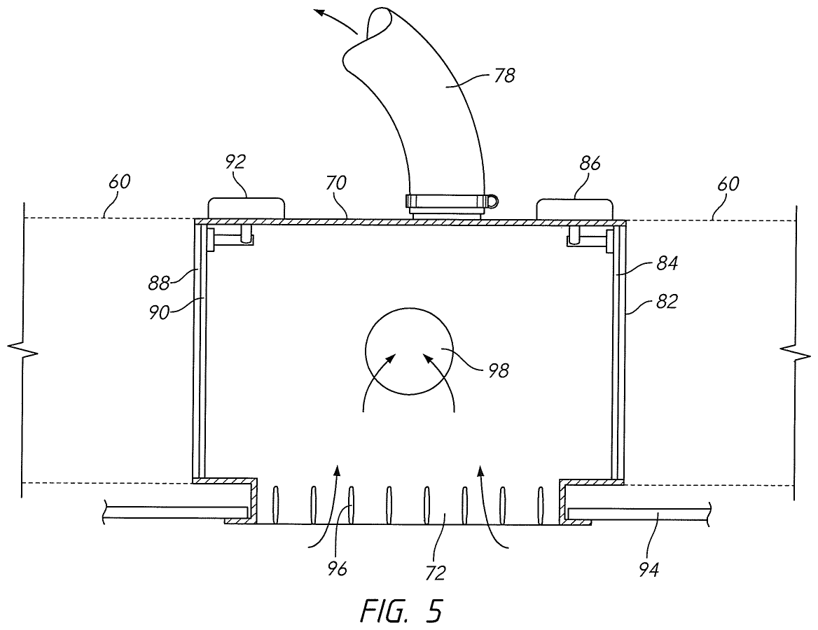

The intent of the inventive system is to provide positive evacuation of the air within the living space of the building or enclosed structure when a dangerous gas is detected. FIG. 4 shows the operation when no such gas is detected. FIG. 5 shows the shift to the evacuation mode once a dangerous gas is detected. Entrance valve 90 and exit valve 84 are closed—stopping all air flow through the HVAC duct (even if the HVAC blower remains active). This stops any further distribution of dangerous gases by the HVAC system. Evacuation intake valve 96 is opened. Evacuation blower 74 (shown in FIG. 3) is energized. Air within the living space is drawn in through evacuation intake 72, in through evacuation blower inlet 98, and propelled by the evacuation blower out through exhaust duct 78. Thus, the evacuation module operates to remove the contaminated air form the living space within the building.

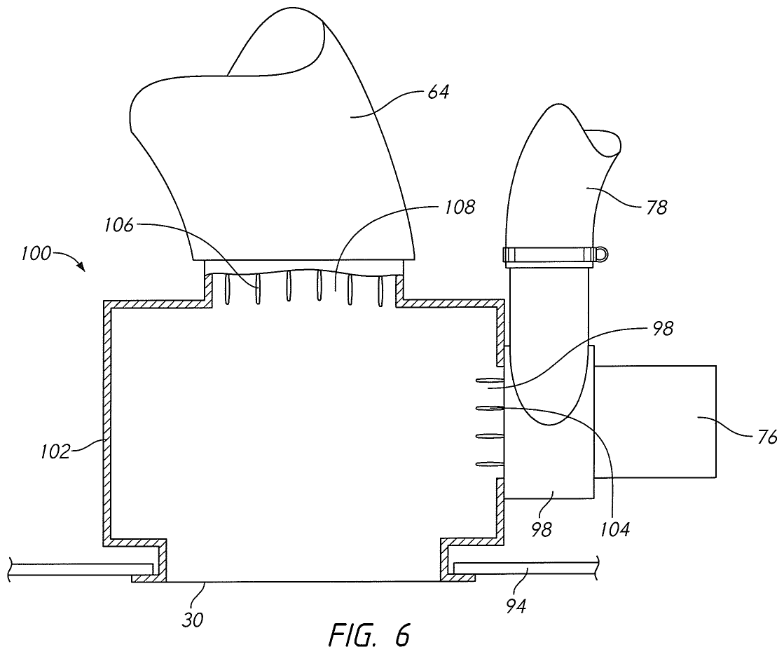

FIGS. 6-8 illustrate the second type of evacuation module—the “air register” type. In this embodiment the evacuation module is located on the end of a duct, rather than in-line. It is advantageous to combine the evacuation module with a conventional air register (though one could provide a separate module attached to an existing air register). FIG. 6 shows an exemplary register/evacuation module 100. Coupler housing 102 has an entrance configured to attach to a duct—in this case a flexible duct 64. Entrance valve 106 regulates flow into coupler housing 102 from the duct. The outlet of the coupler housing assumes the form of an air register 30 attached to an opening in ceiling 94. Exhaust louvers and other conventional air register features may be provided as well. These have not been shown for purposes of visual clarity.

Those skilled in the art will know that an air register is typically attached to more than just the drywall of a ceiling. It is typically attached to surrounding wood or metal structures to provide sufficient strength. This is true of the in-line evacuation modules as well. As these types of connections are well known, they have not been illustrated.

In the embodiment of FIG. 6, evacuation blower 74 is attached to the side of register/evacuation module 100. Motor 76 drives this blower in order to pull air in through evacuation blower inlet 98 and exhaust the air through exhaust duct 78. In the example shown, blower entrance valve 104 selectively closes the inlet 98. As mentioned previously, the blower entrance valve is optional, as the blower itself effectively blocks flow when it is not operating. A valve will block the air slightly more effectively, however.

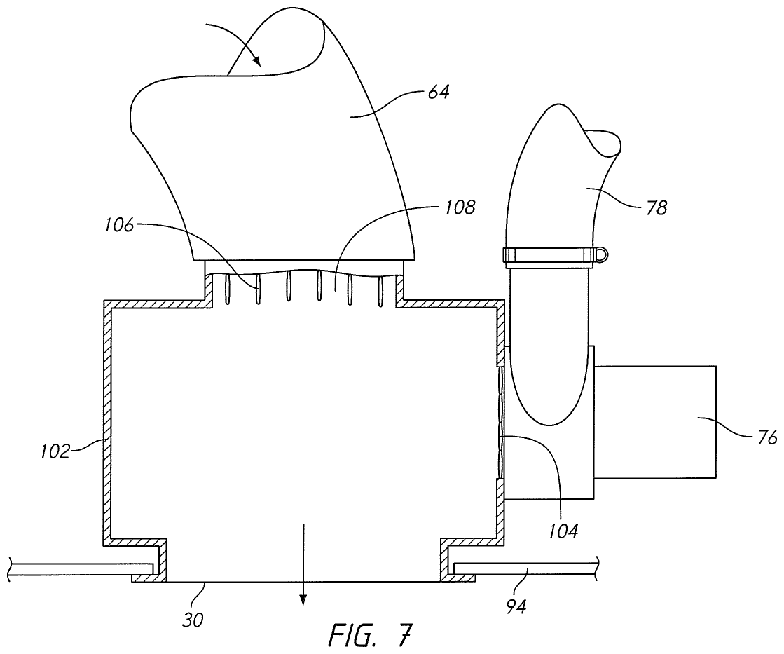

FIG. 7 shows the exhaust module 100 operating in a normal state. HVAC air flows in through duct 64. Entrance valve 106 is open and the duct air therefore flows freely through entrance 108, through coupler housing 102, and out through air register 30. Blower entrance valve 104 is closed, preventing any flow into the blower.

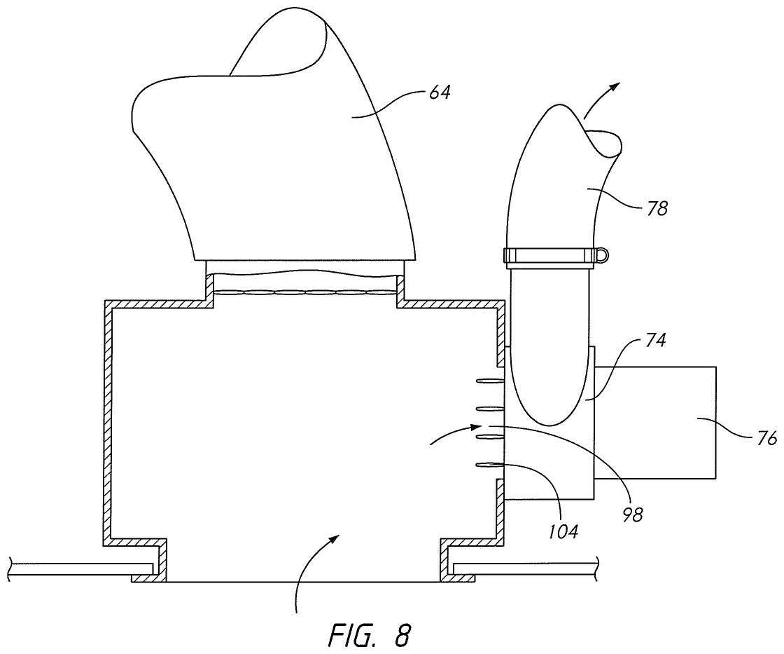

FIG. 8 shows the same module when it is switched into the evacuation mode. Entrance valve 106 is closed, stopping all flow from the HVAC duct. Blower entrance valve 104 is open. Motor 76 is activated to power evacuation blower 74. The evacuation blower then draws the contaminated air out of the living space through register 30 and into the blower through evacuation blower inlet 98. The evacuation blower then propels the contaminated air out through exhaust duct 78.

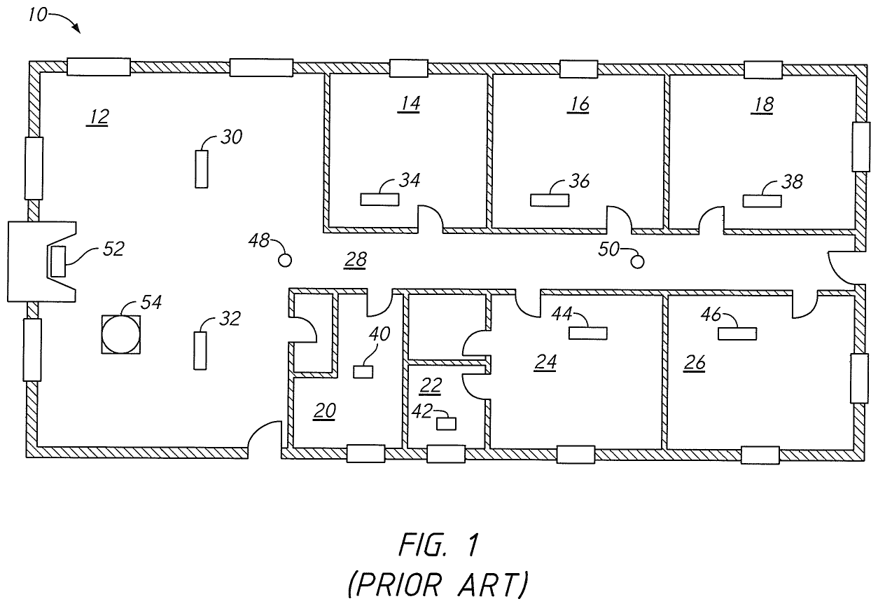

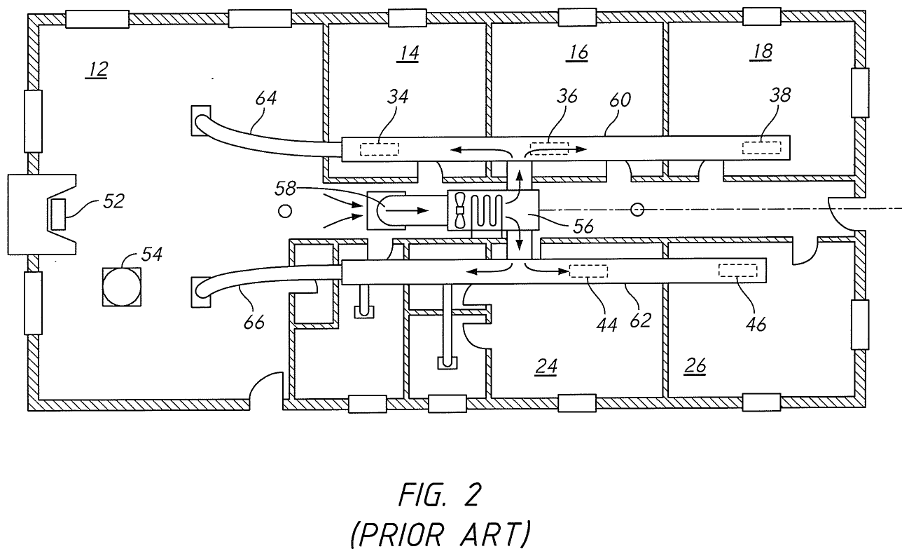

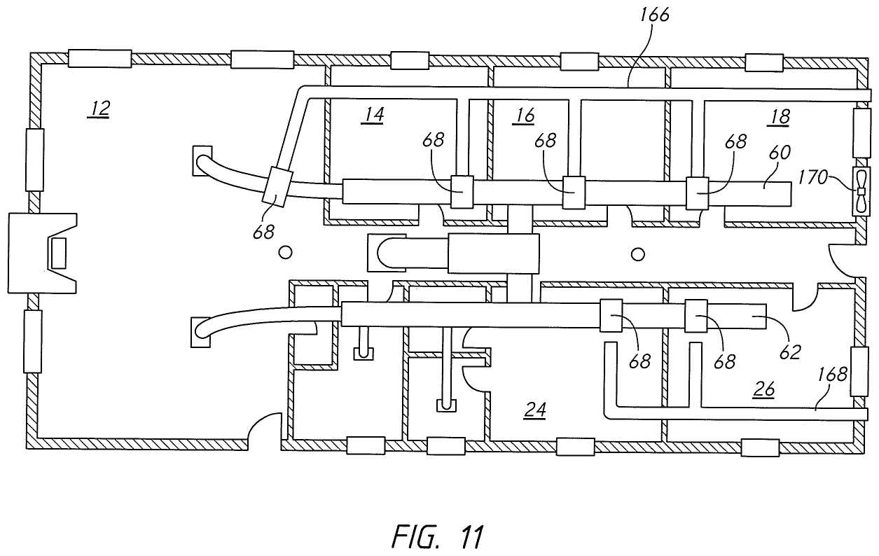

The invention may be installed in an endless variety of structures. In some instances a single evacuation module will suffice. In other instances a dozen or more evacuation modules will be required. FIG. 11 shows an installation of in-line evacuation modules for the exemplary structure of FIGS. 1 and 2. An individual evacuation module 68 is provided for living room 12 and each of the bedrooms 14,16,18,24,26. In this application an evacuation module is added to only one of the two ducts in the living room 12. No evacuation modules are provided for the bathrooms. This selection concentrates on the sleeping areas—where the threat of insidious CO poisoning is greatest. In other applications more evacuation modules will be provided.

In the example of FIG. 11, the exhaust duct 78 from each blower is collected by an evacuation duct 166,168. Evacuation ducts 166,168 are run in the attic. These lead outside the building so that the contaminated air is carried well away.

Another approach is to propel the contaminated air out of the living space and into the attic—then propel it out of the attic. In this approach, the evacuation blower on each evacuation module simply exhausts the contaminated air into the attic. Attic fan 170 is activated to draw the attic air outside of the building.

It is possible to provide an independently acting control system for each evacuation module. As an example, a separate CO detector could be provided on each module and the actions of that module would then be determined by the readings of the single CO detector. It is preferable, however, to provide a centralized control system that is capable of directing the actions of multiple evacuation modules.

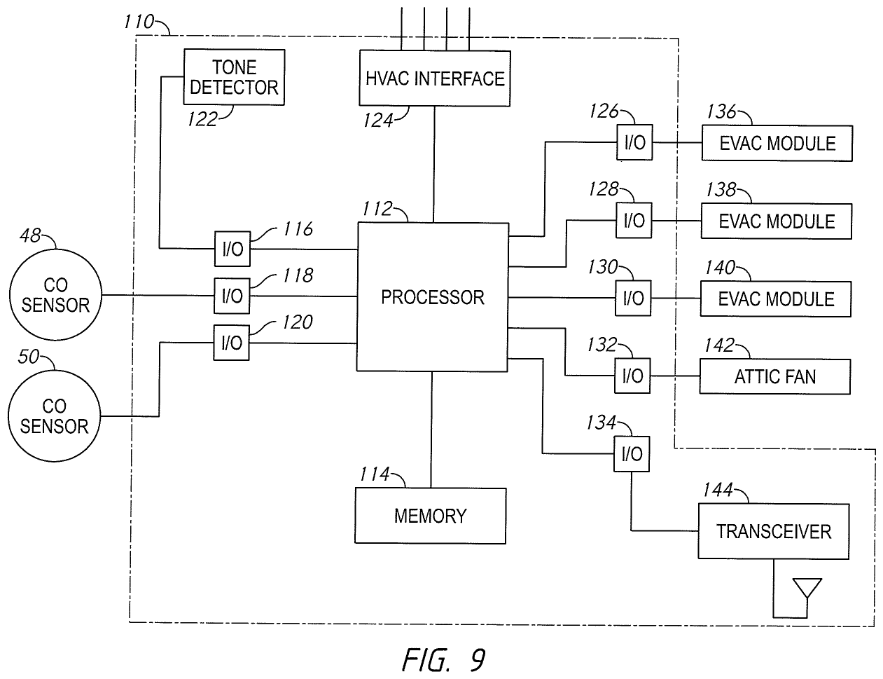

FIG. 9 provides a schematic view of an exemplary centralized control system. System controller 110 includes a processor 112 and an associated memory 114. The processor runs software configured to carry out the inventive process. Numerous input/output (“I/O”) ports are provided for the processor. In this example CO sensors 48, 50 are hardwired to I/O ports 118,120. The CO detectors provide an electrical trigger signal when CO gas is detected beyond a threshold amount. This information is sent to processor 112.

In some instances it is impractical to hardwire one or more CO detectors. In order to account for this possibility, system controller 110 is provided with tone detector 122. Tone detector 122 is set to detect the audible warning tone emitted by a CO detector. When tone detector 122 detects the warning tone, it creates a trigger signal that is sent via I/O port 116 to processor 112.

When processor 112 receives a warning signal from one of the CO sensors (or other dangerous gas detectors), it initiates the evacuation cycle. Each evacuation module 136,138,140 receives a trigger signal form the processor via respective I/O ports 126,128,130. If it is an installation containing an attic fan 142 configured to evacuate the attic, the attic fan is triggered via I/O port 132.

In this example system controller 110 is provided with a transceiver 144 that can provide two-way communications with processor 112 via I/O port 134. The transceiver can be used for many different purposes, such as updating the processor software. It can also be used to provide status messages to an external device such as a “smart home” system. HVAC interface 124 is provided so that the processor can communicate with the building HVAC system. In the event a dangerous gas level is detected it is preferable to switch the HVAC system off (in order to prevent further spreading of the dangerous gas). HVAC interface 124 can switch off the HVAC system. This function can also be carried out wirelessly using transceiver 144.

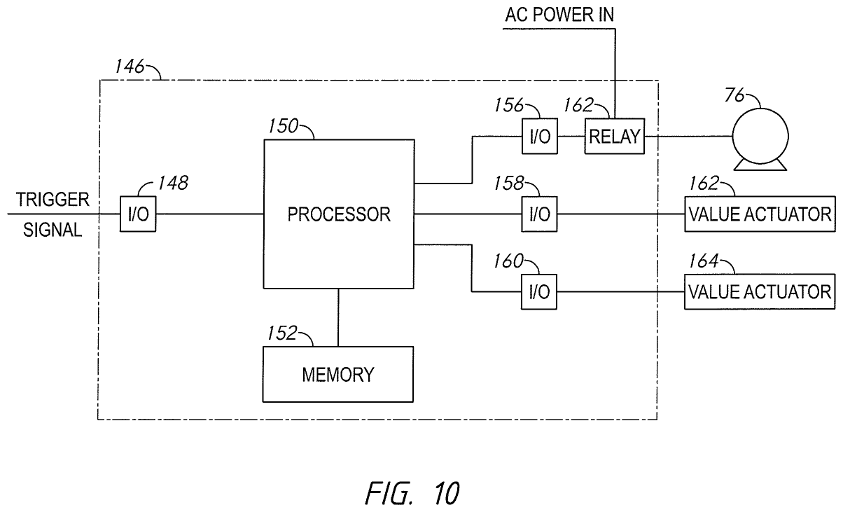

In the version shown in FIG. 9, each evacuation module has its own local controller. In such a system the system controller 110 only needs to send the trigger signal. The local controller on each evacuation module will then receive the trigger signal and perform a series of tasks. An embodiment of an evacuation module controller 146 is shown in FIG. 10. A trigger signal comes from the system controller and is received by I/O port 148. I/O port 148 delivers the trigger signal to processor 150. Processor 150 runs a program stored on its associated memory 152 to carry out the inventive process. I/O ports 158,160 provide actuation signals to valve actuators 162,164, which control the entrance and exit valves described previously (Some embodiments will have more than two valve actuators, so the example of FIG. 10 is only one example).

Blower motor 76 is a high-current device that is fed directly by AC line power in this example. Processor 150 provides a trigger signal through I/O port 156 to close the control coil on relay 162. Relay 162 connects the AC line power to motor 76—causing it to run.

Software running on processor 150 controls all the functions needed to transition the evacuation module from a normal state to an evacuation state. It will (1) Activate the suitable actuators to stop normal flow from the HVAC system, and (2) Activate the evacuation blower.

A back-up power source can be provided to the inventive system to guard against the possibility of power failure. A deep-cycle battery can provide DC power to the control circuit and—through the use of an inverter power supply—can provide AC power to the blower motors for a sufficient interval to evacuate the dangerous gas within a building (such as 30 minutes).

Although the preceding description contains significant detail, it should not be construed as limiting the scope of the invention but rather as providing illustrations of the preferred embodiments of the invention. Those skilled in the art will readily envision many other variations. As an example, an inventive system can be configured to evacuate a small, single room living space in a much larger structure. Alternatively, an inventive system can be configured to evacuate the entire structure. Thus, the language used in the claims shall define the invention rather than the specific embodiments described.

Having described our invention we claim:

1. An evacuation system for evacuating a dangerous gas from an enclosed structure, said structure having an HVAC system with a duct, and said structure having a dangerous gas detector, comprising:
(a) an evacuation module connected to said duct and connected to said enclosed structure;
(b) an evacuation blower having an exhaust duct, said evacuation blower being connected to an evacuation blower intake on said evacuation module;
(c) an entrance valve in said evacuation module configured to switch from an open state wherein said valve permits flow from said duct into said evacuation module and a closed state wherein said valve prevents flow from said duct into said evacuation module;
(d) a system controller connected to said dangerous gas detector and said evacuation module;
(e) said system controller being configured, in response to a detection of said dangerous gas by said dangerous gas detector, to close said entrance valve in said evacuation module and activate said evacuation blower; and
(f) said evacuation blower being configured to pull air from said enclosed structure into said exhaust module and exhaust said air out through said exhaust duct.

2. The evacuation system as recited in claim 1, wherein said evacuation module comprises an air register.

3. The evacuation system as recited in claim 1, wherein said evacuation module is in-line in said duct.

4. The evacuation system as recited in claim 1, wherein said exhaust duct terminates outside of said enclosed structure.

5. The evacuation system as recited in claim 1, wherein:
(a) said structure includes an attic;
(b) said exhaust duct terminates in said attic:
(c) said structure includes an attic fan configured to draw air from said attic and exhaust said air outside said structure; and
(d) said system controller controls said attic fan.

6. The evacuation system as recited in claim 1 wherein said connection between said system controller and said dangerous gas detector comprises a tone detector connected to said system controller, wherein said tone detector is configured to detect a tone emitted by said dangerous gas detector.

7. The evacuation system as recited in claim 1 comprising multiple evacuation modules connected to said system controller.

8. An evacuation system for evacuating a dangerous gas from a building having a living space, said building having an HVAC system with a duct delivering air to said living space, and said living space having a dangerous gas detector, comprising:
(a) an evacuation module connected to said duct and connected to said living space;
(b) an evacuation blower having an exhaust duct, said evacuation blower being connected to an evacuation blower intake on said evacuation module;
(c) an entrance valve in said evacuation module configured to switch from an open state wherein said valve permits flow from said duct into said evacuation module and a closed state wherein said valve prevents flow from said duct into said evacuation module;
(d) a system controller connected to said dangerous gas detector and said evacuation module;
(e) said system controller being configured, in response to a detection of said dangerous gas by said dangerous gas detector, to close said entrance valve in said evacuation module and activate said evacuation blower; and
(f) said evacuation blower being configured to pull air from said living space into said exhaust module and exhaust said air out through said exhaust duct.

9. The evacuation system as recited in claim 8, wherein said evacuation module comprises an air register.

10. The evacuation system as recited in claim 8, wherein said evacuation module is in-line in said duct.

11. The evacuation system as recited in claim 8, wherein said exhaust duct terminates outside of said building.

12. The evacuation system as recited in claim 8, wherein:
(a) said building includes an attic;
(b) said exhaust duct terminates in said attic:
(c) said building includes an attic fan configured to draw air from said attic and exhaust said air outside said building; and
(d) said system controller controls said attic fan.

13. The evacuation system as recited in claim 8 wherein said connection between said system controller and said dangerous gas detector comprises a tone detector connected to said system controller, wherein said tone detector is configured to detect a tone emitted by said dangerous gas detector.

14. The evacuation system as recited in claim 8 comprising multiple evacuation modules connected to said system controller.

15. An evacuation system for evacuating a dangerous gas from a building having a living space, said building having an HVAC system with a duct delivering air to said living space, and said living space having a dangerous gas detector, comprising:
(a) an evacuation module connected to said duct and connected to said living space;
(b) said evacuation module being configured to evacuate air from said living space and exhaust said air through an exhaust duct;
(c) an entrance valve in said evacuation module configured to switch from an open state wherein said valve permits flow from said duct into said evacuation module and a closed state wherein said valve prevents flow from said duct into said evacuation module;
(d) a system controller connected to said dangerous gas detector and said evacuation module; and
(e) said system controller being configured, in response to a detection of said dangerous gas by said dangerous gas detector, to close said entrance valve in said evacuation module and activate said evacuation module to evacuate air from said living space and exhaust said air through said exhaust duct; and

16. The evacuation system as recited in claim 15, wherein said evacuation module comprises an air register.

17. The evacuation system as recited in claim 15, wherein said evacuation module is in-line in said duct.

18. The evacuation system as recited in claim 15, wherein said exhaust duct terminates outside of said enclosed structure.

19. The evacuation system as recited in claim 5, wherein:
(a) said building includes an attic;
(b) said exhaust duct terminates in said attic:
(c) said building includes an attic fan configured to draw air from said attic and exhaust said air outside said building; and
(d) said system controller controls said attic fan.

20. The evacuation system as recited in claim 15 wherein said connection between said system controller and said dangerous gas detector comprises a tone detector connected to said system controller, wherein said tone detector is configured to detect a tone emitted by said dangerous gas detector.
